(19) United States
(12) Patent Application Publication
(10) Pub. No.: US 2008/0115103 A1
(43) Pub. Date: May 15, 2008

(54) Key performance indicators using collaboration lists

(75) Inventors: Andrew E. Datars, Mississauga (CA); Howard M. Crow, Sammamish, WA (US); Michal K. Piaseczny, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/705,989

(22) Filed: Feb. 14, 2007

Related U.S. Application Data
(60) Provisional application No. 60/858,554, filed on Nov. 13, 2006.

(51) Int. Cl. G06F 9/44

(52) U.S. Cl. 717/101

(57) ABSTRACT

Architecture for generating key performance indicators (KPIs) utilizing collaboration lists developed from collaborative sessions on projects to be completed. A web-based collaborative portal provides users the means to collaborate on projects and generate project task lists. Task lists developed and tracked during the web-based collaborative session can be consumed as data for generation of a KPI. Users can view, create and edit KPIs and monitor KPI status via a web page. When a task list item changes, the associated KPI is dynamically updated as well as the associated web page indicator and associated performance information. KPI values can be computed based on the number of list items, percentage of items that meet predetermined criteria, and/or summary calculations of an item property.

### CROSS-REFERENCE TO RELATED APPLICATIONS

This application claims the benefit of U.S. Provisional Patent application Ser. No. 60/858,554 entitled “KEY PERFORMANCE INDICATORS USING COLLABORATION LISTS” and filed Nov. 13, 2006, the entirety of which is incorporated by reference herein.

### BACKGROUND

In order to remain healthy and competitive businesses need to have metrics for determining corporate well-being at all times. In large organizations choosing the right information to monitor can be critical to the success of the company. Key performance indicators (KPIs) provide a means for assisting a company in defining and measuring progress toward organizational as well as corporate goals. KPIs are predetermined quantifiable measurements that reflect certain critical success factors of an organization. For example, in a banking scenario, KPIs can include financial metrics related to the number of loans, the number of high-risk loans, cash on hand, and so on. By monitoring KPIs, the state of the business can be tracked and a course of action prescribed at any given time.

In general, KPIs are addressed in need of being able to establish a set of business policy that summarizes what is potentially a huge amount of data into a simple way (e.g., in the form of a “scorecard”) of saying the business is on track or not on track according to a set of predetermined goals. Typically, the KPIs can include a list of topics (e.g., high-level) that are labeled with indicators (e.g., a red indicator for “not on track” status, a yellow light for “watch” status, or a green light for “on track”) associated with status levels. This is in common practice in many different organizations, particularly in financial reporting where revenue, costs, profits, etc., get reported up the management hierarchy. For large companies the costs associated with generating, maintaining, and reporting the KPIs can be a very expensive proposition in terms of employees and systems to track and summarize the large amounts of data.

KPIs can be applied to virtually any organizational structure. For example, in a collaboration setting, many organizations find that during the course of collaborating and working together people need to compile lists of tasks that must be completed and/or issues that need to be addressed. Typically, there is a dedicated team inside a large organization that develops and implements KPIs for that organization. The challenges associated with driving all the data in conventional KPI solutions include the significant expense for implementation, the high-tech talent required to develop the system and metrics, and personnel needed to manage and maintain the systems. Thus, corporations continue to seek alternative implementations that can provide the same or better results with a reduction in cost and resources.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture provides an automated mechanism for driving metrics in support of key performance indicators (KPIs) by utilizing collaboration lists (e.g., SharePoint™ lists; Windows SharePoint Services™ is a product by Microsoft Corporation) developed from collaborative sessions and associated with tasks or projects. For example, in a product development environment (e.g., software), lists developed and tracked during a collaborative session can be consumed as data for metrics that define the state of the development cycle.

The architecture utilizes a web-based collaborative portal where individuals can connect in a shared workspace environment to collaborate on projects. The web site can also facilitate user access and configuration of KPIs and associated performance information. Accordingly, one or more KPIs can be created and maintained without the need for high-tech talent and the huge outlay of resources normally associated with convention solutions.

As described herein, the KPI system management is a simple and self-service prospect where a user can login and create lists of items to track and then create a list of red, yellow, green status alerts or indicators that are calculated on top of the collaboration list. In other words, the entire process end-to-end can be implemented completely using an employee with a basic level of software skill and appropriate can be suitable for most any team developers, engineers, etc.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates performance management using collaboration lists as inputs to computation of a key performance indicator (KPI).

FIG. 2 illustrates a method of managing performance in accordance with the innovation.

FIG. 3 illustrates an alternative system for selecting list items from separate lists for performance indicator creation.

FIG. 4 illustrates a system where a collaboration web site is employed for list generation and KPI presentation.

FIG. 5 illustrates an exemplary collaboration task list that can be utilized for generating and updating a performance indicator.

FIG. 6 illustrates performance indicator information and associated web parts received and presented by the presentation component.

FIG. 7 illustrates an exemplary user interface for presentation and management of performance indicators and related information.

FIG. 8 illustrates a method of facilitating presentation of performance indicators via 4 web page,

FIG. 9 illustrates a method of creating a performance indicator using information of a collaboration list.

FIG. 10 illustrates a method of selecting a calculation method for a performance indicator.

FIG, 11 illustrates a method of generating a performance indicator based on collaboration list and other performance information.

FIG. 12 illustrates a method of dynamically processing and presenting changes associated with a performance indicator.

FIG. 13 illustrates a block diagram of a generalized system for generating a performance indicator using collaboration and other sources.

FIG. 14 illustrates a block diagram of a generalized system for generating a performance indicator using multiple collaboration sources.

FIG. 15 illustrates an alternative implementation of a system where other performance information systems input performance information to the collaboration system.

FIG. 16 illustrates an alternative implementation of a system where the performance component receives performance information directly from multiple collaboration systems and indirectly from the other performance information systems.

FIG. 17 illustrates a block diagram of a computing system operable to execute performance indicator processing and presentation in accordance with the disclosed architecture.

FIG. 18 illustrates a schematic block diagram of an exemplary computing environment for web-based performance indicator processing and collaboration access.

### DETAILED DESCRIPTION

Many organizations find it efficient and productive that during the course of project management, for example, people collaborating and working together typically compile lists of tasks that need to be completed or issues that need to be addressed. One common way of establishing goals and tracking progress is through the use of key performance indicators (KPIs). Disclosed herein is an automated and dynamic mechanism for driving metrics in support of the creation and maintenance of performance indicators (e.g., KPIs) by utilizing collaboration lists developed from collaborative sessions. For example, in a product development environment (e.g., software), lists developed and tracked during a collaborative session can be consumed as data for metrics that when processed define the state of the development.

More specifically, the architecture can utilize web-based access not only for user collaboration, but also for administration and configuration of performance information. This benefits the fact that KPIs can be created and maintained without the need for high-tech talent and the huge outlay of resources normally associated with convention solutions.

One particular implementation can utilize Windows SharePoint Services™ by Microsoft Corporation, a collaboration environment which facilitates a collection of information (or collaboration lists) that can be shared with team members. For example, the list can be a sign-up sheet for an event or tasks that need to be tracked. Default columns can support tracking track priority, status, task ownership, and time constraints, for example.

When the number of list items becomes significant (e.g., more than about 100) it is frequently very helpful to be able to quickly assess the status of the effort, and to establish goals for completion of the activities. KPIs using collaboration lists allow a group of users to quickly and easily establish a set of goals, and to assess the progress towards those goals.

In the context of a collaboration environment, KPIs generated from collaboration lists address several requirements: KPIs can be created and edited using a simple web page, KPIs can be calculated using data in the collaboration lists, KPIs can be displayed on a web page, KPIs can be filtered to display results for a subset of the tracking data, and KPIs can be displayed using multiple columns for a heat map view.

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

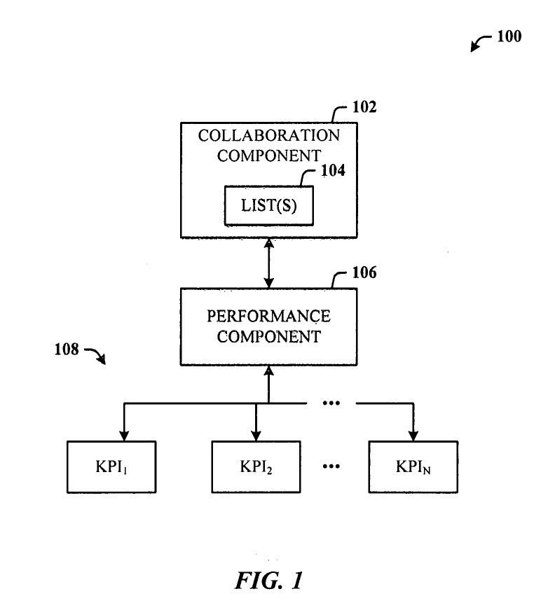

Referring initially to the drawings, FIG. 1 illustrates a system 100 that facilitates performance management using collaboration lists as inputs to computation of a key performance indicator (KPI). The system 100 can include a collaboration component 102 that facilitates collaboration on a project or task by users. As part of the collaboration effort, users can generate one or more lists 104 that define basic elements (or items) of the project or task to be performed. For example, the list(s) 104 can include a task item description for a task item, an owner (e.g., assigned user) of the task item, a priority value that indicates the importance of the item in accomplishing the task, status of the task item, and a time constraint for the task item. A performance component 106 can receive the list(s) 104 and compute one or more KPIs 108 (denoted KPI₁, KPI₂, . . . , KPI_{N}, where N is a positive integer) based on one or more list items of the list(s) 104.

The collaboration component 102 can be part of a web site where users login and collaborate on tasks and projects, for example. Additionally, users can login at times during the ongoing project or task to update the list(s) 104, thereby providing new information for updating the KPIs 108. Users can login to the web site from many different locations and via many different devices (e.g., portable computer, cell phone). Moreover, the task lists 104 and other more detailed information can be presented to the user via a web page. The use of simple lists and list information facilitates utilizing employees, for example, with little required knowledge of KPI-generation. Where the lists are part of a spreadsheet, for example, the user needs only a basic knowledge of spreadsheet data entry. Similarly, where the list is a table in a word processing document, a basic level of word processing is all that is required. No longer are huge outlays in cost and resources in sophisticated programs and high-tech personnel a necessity for KPI generation and maintenance.

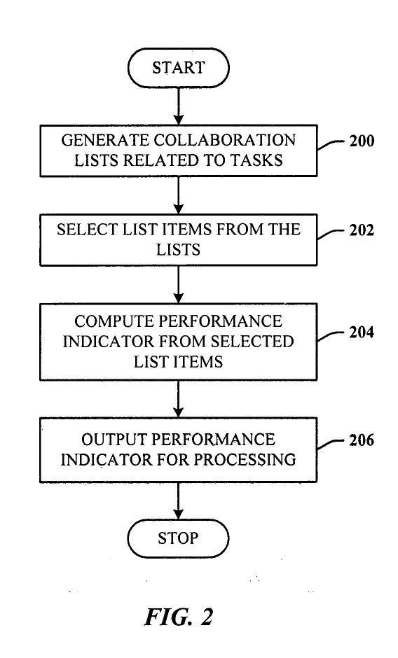

FIG. 2 illustrates a method of managing performance in accordance with the innovation. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, collaboration lists are generated during a collaboration session, the lists related to projects or tasks to be completed. At 202, one or more list items of the lists are selected for computing the performance indicator (e.g., a KPI). At 204, the performance indicator is computed using the selected list items. At 206, the performance indicator is output for further processing (e.g., for presentation via a web page).

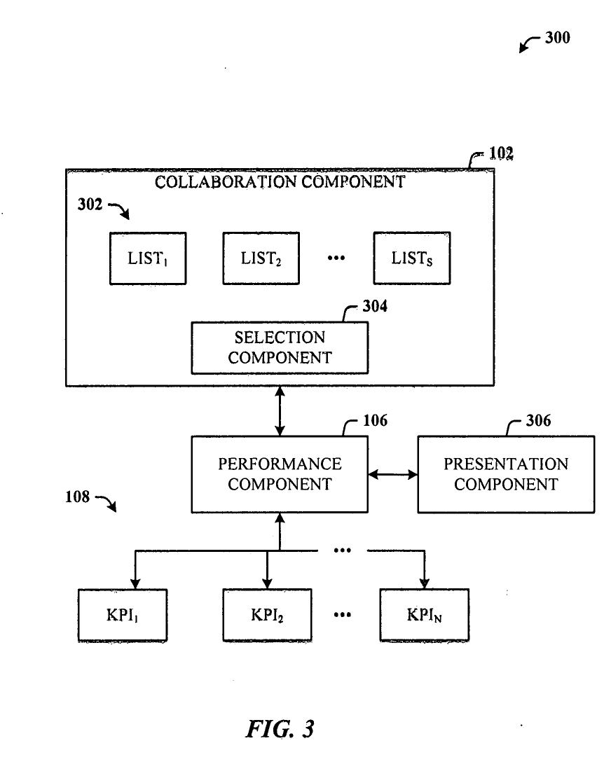

FIG. 3 illustrates an alternative system 300 for selecting list items from separate lists for performance indicator creation. Here, the collaboration component 102 facilitates the creation of multiple project or task lists 302 (denoted LIST₁, LIST₂, . . . , LIST_{S}, where S is a positive integer). A selection component 304 can be configured to select all list items from all of the lists 302, list items from one of the lists 302, or specific list items from one or more of the lists 302, for example. The selected list items or value representations thereof, can then be sent to the performance component 104 for computation of one or more of the KPIs 108 and ultimate presentation using a presentation component 306. Presentation will typically be via a display, and in a more specific example, via a web page. However, it is to be understood that presentation can also be via voice file, video file or other means for communicating information to a recipient who requests the information. For example, if the user is on travel and lacks the capability or connectivity to access the KPI information via a web site, the presentation component 306 can provide the information as a voice file played to the user via a telephone.

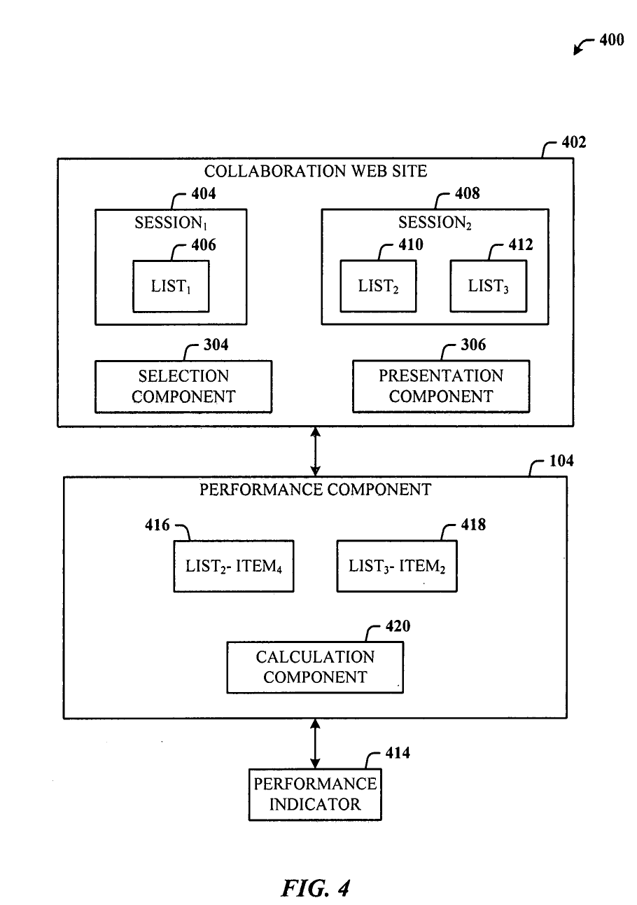

FIG. 4 illustrates a system 400 where a collaboration web site 402 Is employed for list generation and KPI presentation. The web site 402 facilitates one or more sessions to be conducted by project users to generate task lists and priorities. For example, a first session 404 (SESSION₁) is created and conducted to generate a first task list 406 (LIST₁). A second session 408 conducted concurrently with or at a time different from the first session 404 facilitates generation of two lists: a second task list 410 (LIST₂) and a third task list 412 (LIST₃).

The selection component 304 facilitates selection of one or more of the lists (406, 410 and 412) and/or list items for processing by the performance component 104 into a performance indicator 414 (e.g., KPI). For example, here, the selector component 304 is controlled to select no task items from the first task list 406, a fourth item 416 (denoted LIST₁-ITEM₄) from the second task list 410 and a second item 418 (denoted LIST₃-ITEM₂) from the third task list 412. Note that when referred to herein as selecting a task item or task list for generation of a performance indicator, it is intended to also mean that computed values representative of the items and/or lists can be passed to the performance component 104 for processing into the performance indicator 414. This can also include selecting one or more parameters from a task Item for computation of the indicator 414.

The performance component 104 can include a calculation component 420 for processing the list items (416 and 418) into a performance value for presentation as the indicator 414. The presentation component 306 can present the indicator and/or performance value via the web site 402. The presentation component 306 also facilitates user interaction during the sessions (404 and 408) and with a user interface that presents performance indicator information,

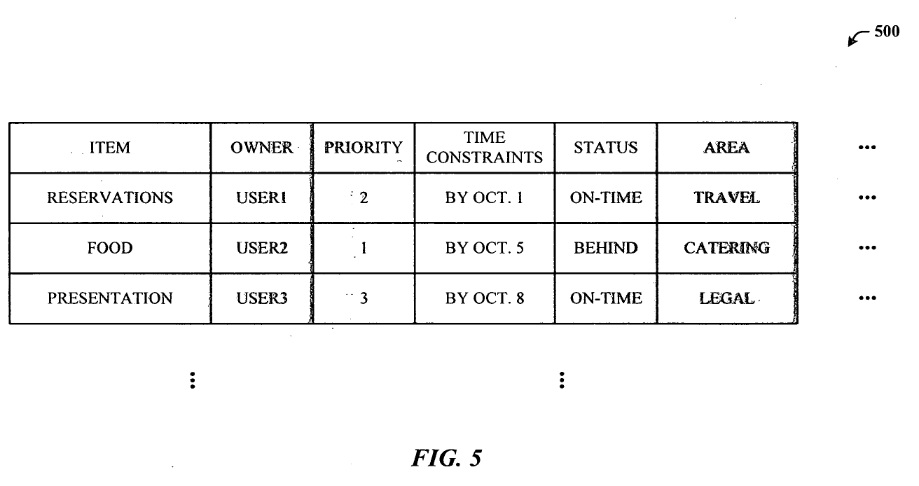

FIG. 5 illustrates an exemplary collaboration task list 500 that can be utilized for generating and updating a performance indicator. The list 500 can be a table (e.g., word processing or spreadsheet) having many column headings, as desired for describing the desired task information. For example, the list can include an Item heading for describing a task Item (e.g., reservations, food, presentation), an Owner heading for listing a user (e.g., User1, User2, User3) for the task item, a Priority column for indicating a priority value for the task item, a Time Constraint column the can include temporal data (e.g., deadline date, time) of the given task item, a Status heading for holding status information (e.g., On-time, Behind) for the task item, and an Area column for indicating a general category of group in the company that performs the function in the task item. These are only a few of the headings and types of information that can be utilized in the collaboration list 500. The information and headings can be configured for the particular application and linked to the performance component for calculation of the performance indicator. As will be described infra, the list information can be derived wholly from a collaborative session, partly from the session and partly from another performance information source, for example.

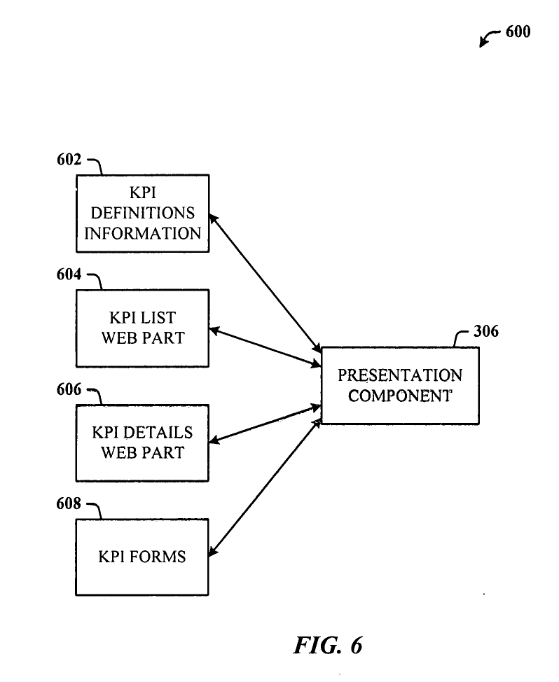

FIG. 6 illustrates performance indicator information and associated web parts received, utilized, and presented by the presentation component 306. The presentation component 306 can receive and present KPI definitions information 602, a KPI collaboration list web part 604, a KPI details web part 606, and KPI forms 608. The definitions 602 describe the particular performance indicator and the source of information (e.g., task list, task list item) from which it is derived. The list web part 604 is an area of the user interface as provided by the presentation component 306 that presents a listing of the performance indicators in use or that have been employed in the past, for example, and associated description information.

The details web part 606 is an area of the user interface as provided by the presentation component 306 that presents more specific information for a single performance indicator, such as information related to the task items selected for generation of the performance indicator. Based on the example list of FIG. 5, this can include the Item description, priority value, status information, time constraint data, and do on. The forms 608 facilitate creation and updating of the performance indicator information.

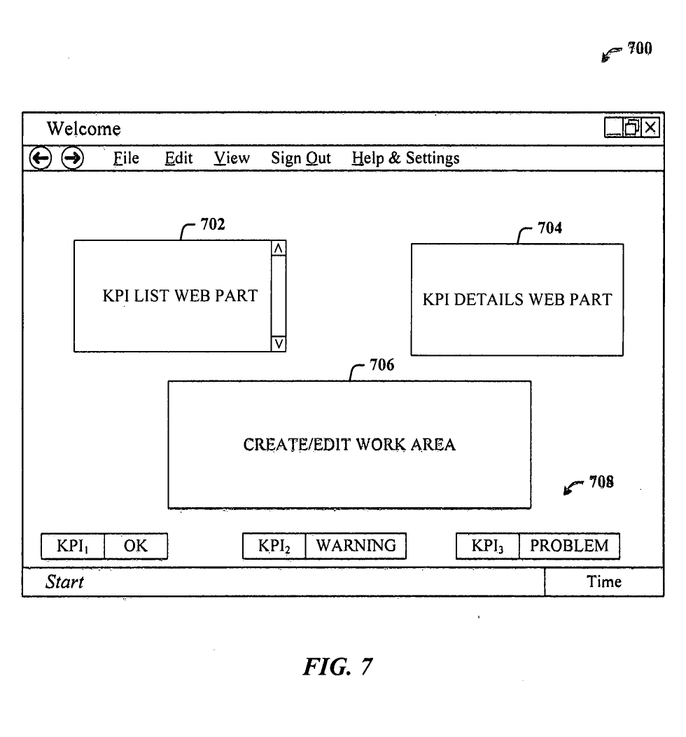

FIG. 7 illustrates an exemplary user interface (UI) for presentation and management of performance indicators and related information. The UI 700 facilitates access to the indicator information via a web browser. Here, the UI 700 includes a KPI collaboration list web part 702 for displaying multiple KPIs. A details web part 704 facilitates the presentation of detailed information about one KPI, A create/edit work area 706 facilitates the presentation of one or more forms for generating and maintaining a KPI. KPI indicators 708 can also be provided as realtime feedback of performance indicators. Here, three KPIs are presented: a first KPI (KPI₁) and associated status as OK, a second KPI (KPI₂) and associated WARNING status, and a third KPI (KPI₃) and associated PROBLEM status. The status information can employ colors and audio alerts, for example.

Moreover, the list web part 702 can present the KPIs in heat map view. Heat maps facilitate expedite visual interpretation of the state of several KPIs. Heat maps can be configured to update at prescribed time intervals (e.g., once a minute) and display colors along with the KPIs. Trends can be readily observed by viewing changes in colors as time changes. For example, in the morning one KPI may indicate a red color, while later in the afternoon the color may change to green, indicating that the particular KPI was in a Problem state in the morning but improved to an Ok state in the afternoon. Many different conventional types of user functionality can be provided such as, for example, automatically exposing information by hovering a mouse pointer over a piece of information, linking a listed KPI to other information that is presented once the KPI is selected (e.g., clicked on), and so on.

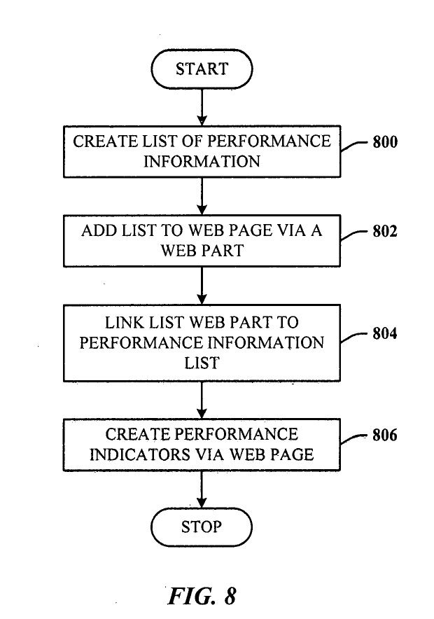

FIG. 8 illustrates a method of facilitating presentation of performance indicators via a web page. At 800, a collaboration task list of performance information is created during a collaboration session. At 802, the list is added to a web page as a web part. At 804, the web part and collaboration list are linked. At 806, the user accesses the web page and creates a performance indicator based on the list.

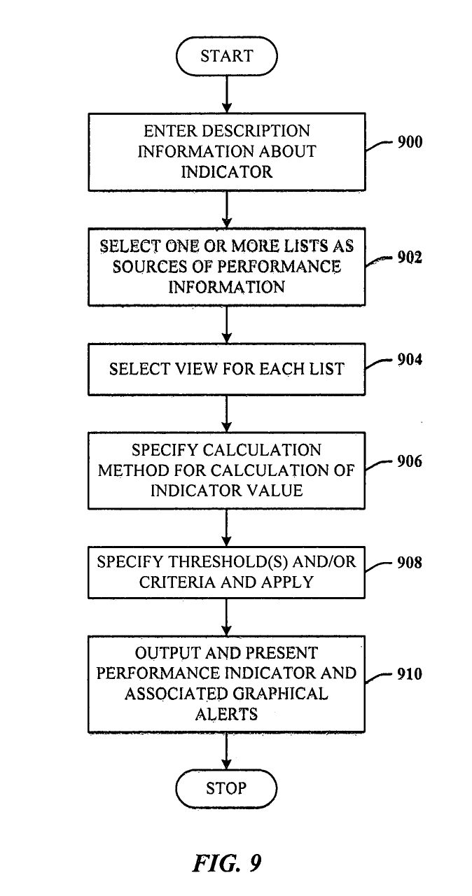

FIG. 9 illustrates a method of creating a performance indicator using information of a collaboration list. At 900, description information about the indicator is entered. This can include the indicator name and a brief description about what it represents. At 902, one or more collaboration lists are selected as sources of performance information. At 904, a view is selected for each list. In other words, the view can include a subset of the list information such as only selected task items of the task list, or only selected parameters across task items, for example. At 906, the calculation methodology is selected for calculating the indicator value. The methodology can include a count of items in the view, a percentage of list items where a criteria or threshold is met, or a summary calculation of a property (e.g., total, average, minimum, maximum, or standard deviation). At 908, a threshold or other criteria can be defined and applied. At 910, the performance indicator value is output and presented along with graphical alert.

A performance indicator (e.g., KPI) can be displayed as a changing graphical icon when the current value of the indicator is within an established range. For example, in one example, the indicator can have three ranges of values that are represented by textual alerts, for example, ‘OK’, ‘Warning’, and ‘Problem’. The graphical icon displayed for each of the ranges can be made configurable. When the information in the selected list is updated, the value of the indicator, and potentially the icon representing its status, are automatically and dynamically updated. The thresholds can be specified for the ease where greater values are better, or lower values are better at the discretion of the user.

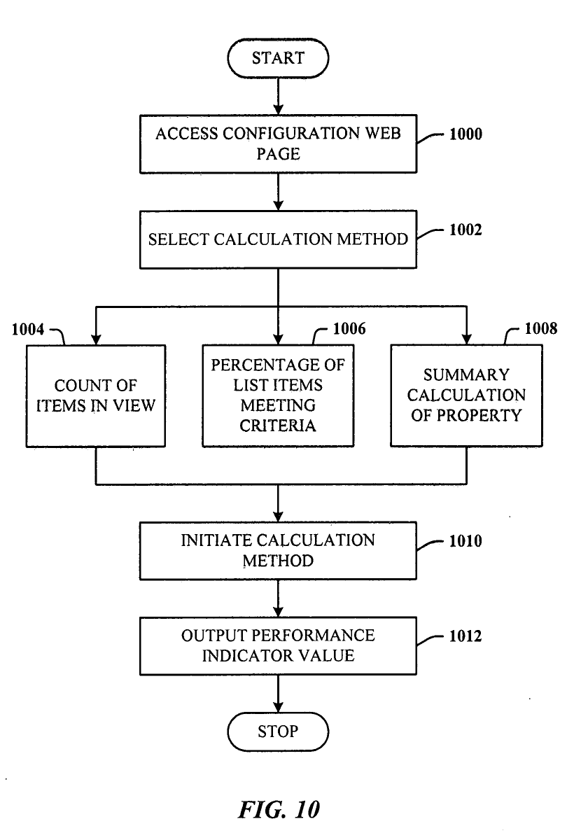

FIG. 10 illustrates a method of selecting a calculation method for a performance indicator. This can be made a selection setting via the web page UI 700 of FIG. 7. At 1000, a user accesses a configuration web page. At 1002, the calculation method is selected for computing the performance indicator. This can be based on the selected lists and views of the lists. In one implementation, the user can manually select the calculation method. In an alternative implementation, the selection can be automatic based on the selected lists and/or list views. This can also be made a configuration setting via the web page UI 700. At 1004, the calculation method counts the number of items in the view. Alternatively, at 1006, the calculation method computes a percentage of the of the list items meeting a predetermined criteria or threshold. Still alternatively, the calculation method is a summary calculation of a property (e.g., total, average, minimum, maximum, or standard deviation). In yet another implementation, a combination of the three methods can be employed. At 1010, the selected method can be initiated (e.g., automatically or manually). At 1012, the performance indicator value can then be computed using the selected method(s), and output for presentation processing.

FIG. 11 illustrates a method of generating a performance indicator based on collaboration list and other performance information. At 1100, a collaboration list or portions thereof are received for creating a performance indicator. This can be a manual or automated receive operation. At 1102, other performance information from a source other than collaboration is received. Similarly, this can be a manual or automated receive operation. At 1104, all or portions of the collaboration list and/or other performance information are selected for generating the performance indicator. At 1106, a performance indicator value is computed based on the selected portions. At 1108, performance indicator information is output and presented. The performance indicator information can be graphical information other than the value itself, and/or the value can be output directly for viewing.

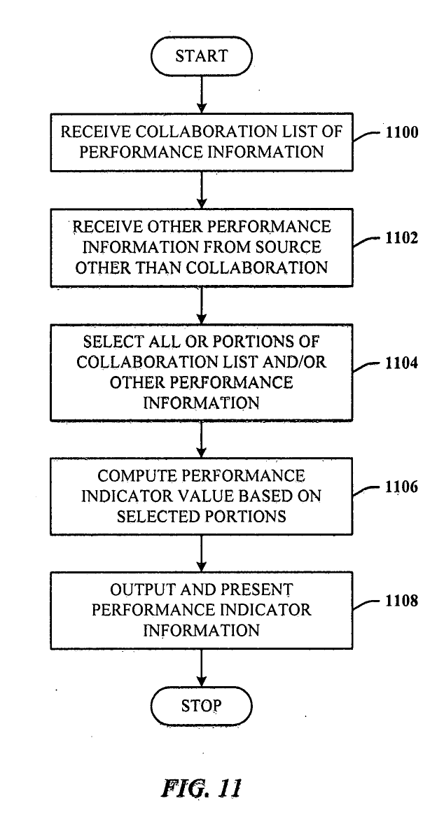

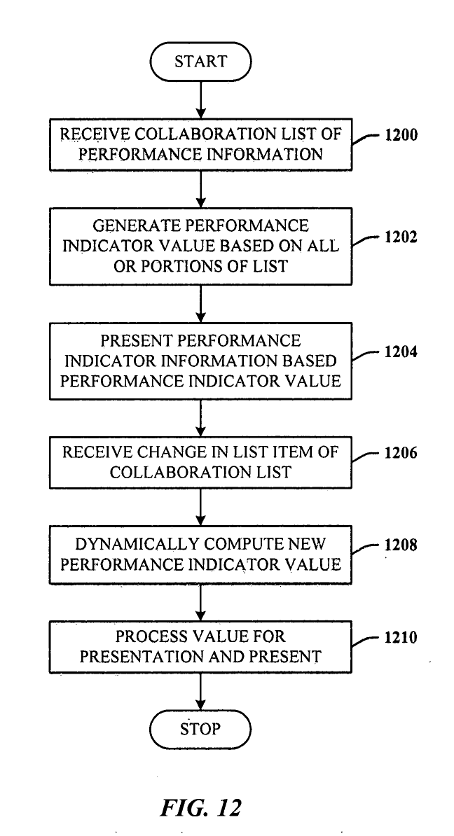

FIG. 12 illustrates a method of dynamically processing and presenting changes associated with a performance indicator. At 1200, a collaboration list of performance information is received. At 1202, a performance indicator value is generated based on all or portions of the list. At 1204, performance indicator information is presented based on the value. At 1206, a change in a list item (e.g., a list item parameter) is received. At 1208, the system dynamically computes a new performance indicator value and presents the value, as indicated at 1210. The dynamic nature of the disclosed architecture ensures that the user will receive and view (e.g., via a web page) the latest performance information in a timely manner.

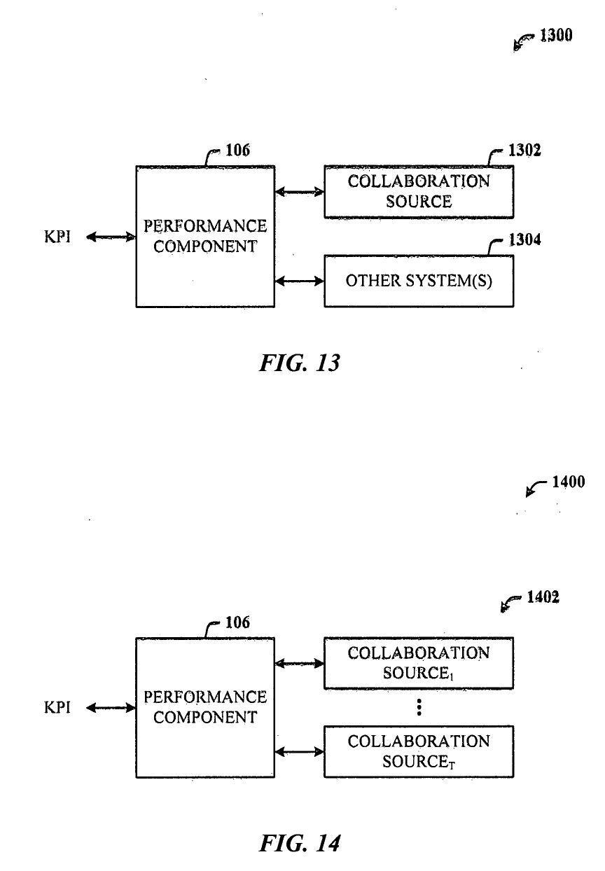

FIG. 13 illustrates a block diagram of a generalized system 1300 for generating a performance indicator using collaboration sessions and other sources. The performance component 106 receives collaboration information from a collaboration source 1302 and other performance information from one or more other system(s) 1304. Accordingly, the performance component 106 can facilitate computation of a KPI based on only the collaboration source 1302, only the other performance information of the one or more other system(s) 1304, or both sources (1302 and 1304).

FIG. 14 illustrates a block diagram of a generalized system 1400 for generating a performance indicator using multiple collaboration sources 1402. The performance component 106 can facilitate computation of the KPI based on lists or items of the lists of the collaboration sources 1402 (denoted COLLABORATION SOURCE₁, . . . , COLLABORATION SOURCE_{T}, where T is a positive integer). Selection can be from one or more of the sources 1402, from specific lists and specific list items.

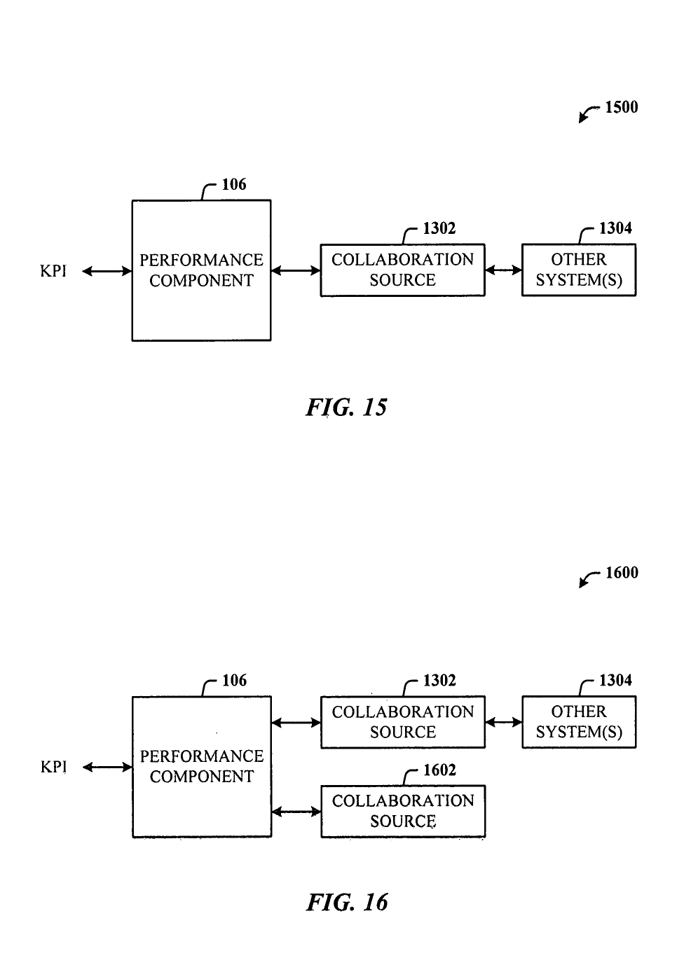

FIG. 15 illustrates an alternative implementation of a system 1500 where other performance information systems 1304 input performance information to the collaboration system 1302. Here, the other performance information for the other systems 1304 can be used to populate a partial section of a collaboration list, and thereafter, the list or portions thereof can be sent to the performance component 106 for computation and output of the KPI.

FIG. 16 illustrates an alternative implementation of a system 1600 where the performance component 106 receives performance information directly from multiple collaboration systems and indirectly from the other performance information systems 1304. Here, the other performance information from the other systems 1304 can be used to populate a partial section of the list or the entire collaboration list, and thereafter, the list or portions thereof can be sent to the performance component 106 for computation and output of the KPI. Additionally, a second collaboration source 1602 provide list information directly to the performance component 106. The performance component 106 then computes and outputs the KPI based on the performance information received from selected inputs (e.g., all or portions thereof).

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

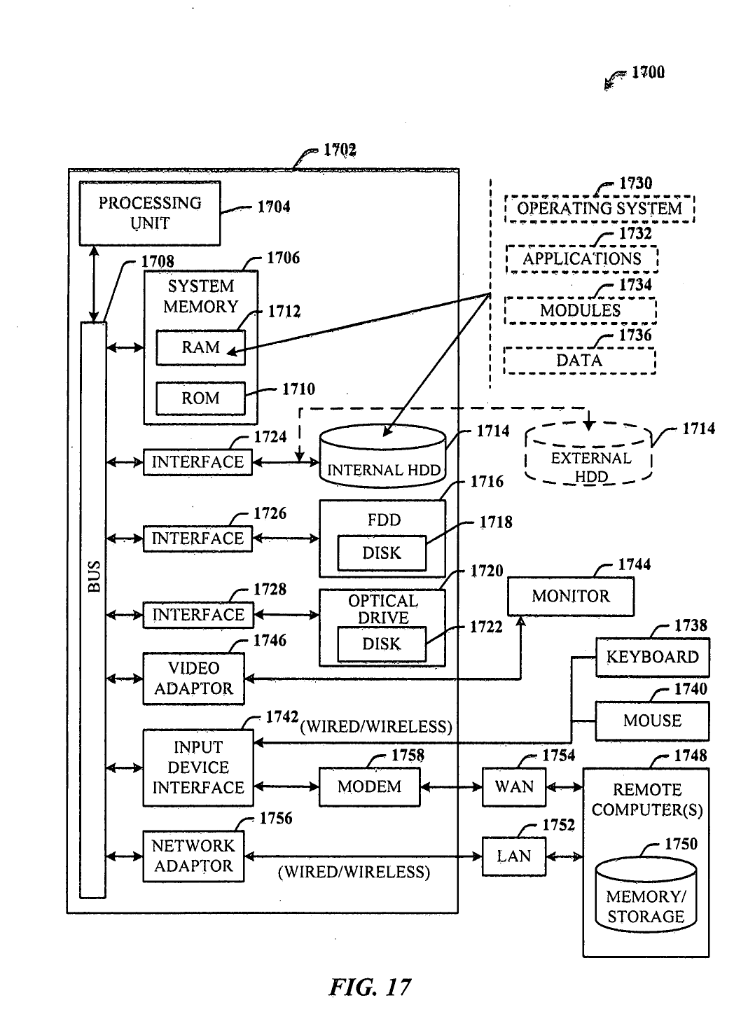

Referring now to FIG. 17, there is illustrated a block diagram of a computing system 1700 operable to execute performance indicator processing and presentation in accordance with the disclosed architecture. In order to provide additional context for various aspects thereof, FIG. 17 and the following discussion are intended to provide a brief, general description of a suitable computing system 1700 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 17, the exemplary computing system 1700 for implementing various aspects includes a computer 1702, the computer 1702 including a processing unit 1704, a system memory 1706 and a system bus 1708. The system bus 1708 provides an interface for system components including, but not limited to, the system memory 1706 to the processing unit 1704. The processing unit 1704 can be any of various commercially available processors. Dual microprocessors and other multi-processor architectures may also be employed as the processing unit 1704.

The system bus 1708 can be any of several types of bus structure that may further interconnect to a memory bus (with or without a memory controller), a peripheral bus, and a local bus using any of a variety of commercially available bus architectures. The system memory 1706 includes read-only memory (ROM) 1710 and random access memory (RAM) 1712. A basic input/output system (BIOS) is stored in a non-volatile memory 1710 such as ROM, EPROM, EEPROM, which BIOS contains the basic routines that help to transfer information between elements within the computer 1702, such as during start-up. The RAM 1712 can also include a high-speed RAM such as static RAM for cashing data.

The computer 1702 further includes an internal hard disk drive (HDD) 1714 (e.g., EIDE, SATA)₁ which internal hard disk drive 1714 may also be configured for external use in a suitable chassis (not shown), a magnetic floppy disk drive (FDD) 1716, (e.g., to read from or write to a removable diskette 1718) and an optical disk drive 1720, (e,g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1712, including an operating system 1730, one or more application programs 1 732, other program modules 1734 and program data 1736. The modules 1734 can include the collaboration and performance components (102 and 106), as well as the selection component 304 and calculation component 420, for example. All or portions of the operating system, applications, modules, and/or data can also be cached in the RAM 1712. It is to be appreciated that the innovation can be implemented with various commercially available operating systems or combinations of operating systems.

A user can enter commands and information into the computer 1702 through one or more wired/wireless input devices, for example, a keyboard 1738 and a pointing device, such as a mouse 1740. Other input devices (not shown) may include a microphone, an IR remote control, a joystick, a game pad, a stylus pen, touch screen, or the like. These and other input devices are often connected to the processing unit 1704 through an input device interface 1742 that is coupled to the system bus 1708, but can be connected by other interfaces, such as a parallel port, an IEEE 1394 serial port, a game port, a USB port, an IR interface, etc.

A monitor 1744 or other type of display device is also connected to the system bus 1708 via an interface, such as a video adapter 1746. In addition to the monitor 1744, a computer typically includes other peripheral output devices (not shown), such as speakers, printers, etc.

The computer 1702 may operate in a networked environment using logical connections via wired and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, for example, a wide area network (WAN) 1754. Such LAN and WAN networking environments are commonplace in offices and companies, and facilitate enterprise-wide computer networks, such as intranets, all of which may connect to a global communications network, for example, the Internet.

When used in a LAN networking environment, the computer 1702 is connected to the local network 1752 through a wired and/or wireless communication network interface or adapter 1756. The adaptor 1756 may facilitate wired or wireless communication to the LAN 1752, which may also include a wireless access point disposed thereon for communicating with the wireless adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wired or wireless device, is connected to the system bus 1708 via the serial port interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluotooth™ wireless technologies. Thus, the communication can be a predefined structure as with a conventional network or simply an ad hoc communication between at least two devices.

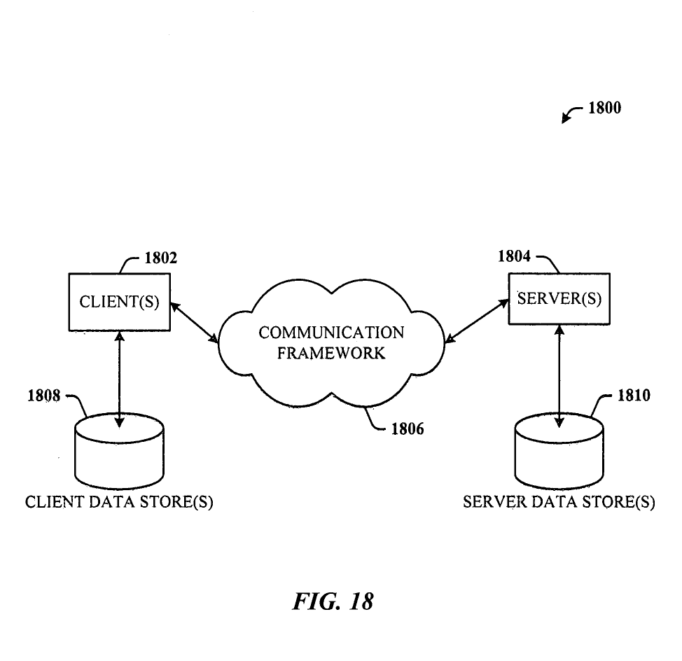

Referring now to FIG. 18, there is illustrated a schematic block diagram of an exemplary computing environment 1800 for web-based performance indicator processing and collaboration access. The system 1800 includes one or more client(s) 1802 for accessing a web-based collaboration environment. The client(s) 1802 can be hardware and/or software (e.g., threads, processes, computing devices). The client(s) 1802 can house cookie(s) and/or associated contextual information by employing the subject innovation, for example.

The system 1800 also includes one or more server(s) 1804 that can provide the collaboration services and web-based performance information configuration and maintenance. The server(s) 1804 can also be hardware and/or software (e.g., threads, processes, computing devices). The servers 1804 can house threads to perform transformations by employing the architecture, for example. One possible communication between a client 1802 and a server 1804 can be in the form of a data packet adapted to be transmitted between two or more computer processes. The data packet may include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g., cookie(s) and/or associated contextual information). Similarly, the server(s) 1804 are operatively connected to one or more server data store(s) 1810 that can be employed to store information local to the servers 1804.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of tile appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilities performance management, comprising;
a collaboration component for generating collaboration information related to a task; and
a performance component for, automatically utilizing the collaboration information for generation of a key performance Indicator (KPI).

2. The system of claim 1, wherein the collaboration component includes a collaboration web site that receives task status information related to the task.

3. The system of claim 1, wherein the performance component computes a value of the KPI based on a count of items in a view.

4. The system of claim 1, wherein the performance component computes a value of the KPI based on a percentage of list items that meet a criterion,

5. The system of claim 1, wherein the performance component computes a value of the KPI based on a summary calculation of a property.

6. The system of claim 1, further comprising a presentation component for presenting a list of KPI definitions.

7. The system of claim 1, further comprising a presentation component that includes a form for creating and modifying a KPI.

8. The system of claim 1, further comprising a presentation component that includes a details web part for presenting one KPI.

9. The system of claim 1, further comprising a presentation component that includes a list web part for presenting multiple KPIs.

10. The system of claim 1, further comprising a selection component for selecting collaboration Information from one or more collaboration lists of task items.

11. A computer-implemented method of managing performance, comprising:
receiving collaboration lists form a collaboration environment, the lists related to tasks;
selecting list data from the lists;
computing a performance indicator form the selected list data; and
outputting the performance indicator for processing.

12. The method of claim 11, further comprising dynamically updating the performance indicator based on changes in the collaboration lists.

13. The method of claim 11, further comprising creating and editing a performance indicator via a web page form.

14. The method of claim 11, further comprising displaying the performance indicator via a web page.

15. The method of claim 11, further comprising filtering a plurality of the performance indicators to display a subset of list items of the lists.

16. The method of claim 11, further comprising dynamically changing presentation of the performance indicator based on a change in the list data.

17. The method of claim 11, further comprising computing a value for the performance indicator using a count of the list items or a percentage of the list items that meet a threshold.

18. The method of claim 11, further comprising linking the lists with a web page for automatic presentation of the performance indicator and associated indicator information.

19. The method of claim 11, further comprising automatically receiving task information into a collaboration list from an external system, and computing the performance indicator based on the external system and the collaboration lists.

20. A computer-implemented system, comprising:
computer-implemented means for generating task lists in a collaboration environment via a web page;
computer-implemented means for selecting task parameters from the task lists;
computer-implemented means for computing a performance indicator from the selected task parameters; and
computer-implemented means for presenting the performance indicator via the web page.
